(19) United States
(12) Patent Application Publication
(10) Pub. No.: US 2008/0242793 A1
(43) Pub. Date: Oct. 2, 2008

(54) Fiber-Reinforced Resin Composition and Molded Body Thereof

(75) Inventor: Koki Yano, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: PRIME POLYMER CO., LTD, Minato-ku, Tokyo (JP)

(21) Appl. No.: 10/592,718

(22) PCT Filed: Mar. 23, 2005
(86) PCT No.: PCT/JP05/05218

§ 371 Date: Sep. 13, 2006

(30) Foreign Application Priority Data
Mar. 29, 2004 (JP) 2004-096782

(51) Int. Cl. C08K 3/04

(52) U.S. Cl. 524/496

(57) ABSTRACT

Disclosed is a fiber-reinforced polyolefin resin composition containing (A) 1-20 mass % of carbon fibers having a fiber diameter of 3-20 μm, (B) 3-50 mass % of black lead (graphite) having an average particle diameter of 1-100 μm, and (C) 25-95 mass % of a polyolefin resin, wherein the mass ratio of the black lead (graphite) (B) (Wg) to the carbon fibers (A) (Wcf), namely mass ratio (Wg/Wcf), is 1-10. Also disclosed is a molded body of such a fiber-reinforced polyolefin resin composition.

### TECHNICAL FIELD

The present invention relates to a fiber reinforced resin composition, and a molded product obtained therefrom. More specifically, the invention relates to a carbon-fiber-containing, fiber reinforced resin composition for giving a molded product small in curvature deformation, and a molded product obtained therefrom.

### BACKGROUND ART

It is well known that: when fiber reinforced polyolefin based resin is molded, anisotropy of the shrinkage ratio is expressed by the orientation of the fibers so that the resultant molded product warps or deforms; therefore, the product is hindered from being used in various articles. In the case that polyolefin based resin is reinforced with carbon fiber, the addition of a relatively small amount thereof makes it possible to improve the rigidity, strength and heat resistance than in the case that inorganic fillers other than the carbon fiber are used. Conversely, curvature and deformation are easily generated. Thus, a method for decreasing the curvature is necessary.

As the curvature-decreasing method, a method of adding an elastomer to the resin is known (JP-A-H3-223356). However, the method has a problem that when an elastomer is added thereto, an improvement in the rigidity and strength of the resultant, which is a primary object of the addition of reinforcing fiber, deteriorates. A method of adding thereto a plate-like inorganic filler such as mica (JP-A-H2-238038, and JP-A-H4-25541) and other methods are also known. However, the methods have problems that when a large amount of an inorganic filler other than carbon fiber is added to the resin, characteristics of the carbon fiber material are damaged as follows: the density becomes large (gets heavy); and the ash content therein becomes large to cause a problem at the time of incineration disposal.

In light of the above-mentioned problems, the present invention has been made. An object thereof is to provide a composition which can give a molded product small in curvature while keeping characteristics of a carbon fiber material, such as a low density, a low ash content and a high rigidity.

### DISCLOSURE OF THE INVENTION

In order to attain the above-mentioned object, the inventors have repeated eager research, so as to find out that a molded product comprising a fiber reinforced resin composition wherein a carbon fiber material and graphite is blended at a specific ratio has a small curvature and a small deformation due to the plate-like shape of graphite. Thus, the present invention has been completed.

The present invention provides:

[1] a fiber reinforced polyolefin based resin composition, which comprises 1 to 25% by mass of (A) a carbon fiber having a filament diameter of 3 to 20 μm, 3 to 50% by mass of (B) a graphite having an average particle size of 1 to 100 μm, and 25 to 95% by mass of (C) a polyolefin based resin, wherein the ratio of the mass Wg of the graphite to the mass Wcf of the carbon fiber (Wg/Wcf) is from 1 to 10;
[2] the composition according to [1], wherein the carbon fiber (A) is contained at a ratio of 1 to 20% by mass;
[3] the composition according to [1] or [2], which further comprises 0.1 to 20 parts by mass of (D) a functional-group-containing polyolefin per 100 parts by mass of the total of the carbon fiber (A), the graphite (B) and the polyolefin based resin (C);
[4] the composition according to any one of [1] to [3], wherein the polyolefin based resin is a polypropylene based resin;
[5] the composition according to any one of [1] to [4], which has an ash content of 3% or less by mass when the composition is burned at 900° C. in the presence of oxygen for 6 hours;
[6] a molded product obtained by molding the composition according to any one of [1] to [5];
[7] the molded product according to [6], which has a density of 1100 kg/m³ or less; and
[8] the molded product according to [6] or [7], which has a flexural modulus of 3000 MPa or more.

According to present invention, there can be provided a fiber reinforced resin composition which can give a molded product small in curvature and deformation while keeping characteristics of a carbon fiber material, such as a low density, a low ash content and a high rigidity, by blending the carbon fiber material with graphite.

According to the present invention, there can be provided a fiber reinforced resin molded product small in curvature and deformation.

### BRIEF DESCRIPTION OF THE DRAWING

FIG. 1 is a view for explaining how to determine curvature ratios of the fiber reinforced resin compositions of Examples and Comparative Examples.

### BEST MODES FOR CARRYING OUT OF THE INVENTION

The invention is described in detail hereinafter.

The fiber reinforced polyolefin based resin composition of the invention comprises:

1 to 25% by mass of (A) a carbon fiber having a filament diameter of 3 to 20 μm,

3 to 50% by mass of (B) a graphite having an average particle size of 1 to 100 μm, and

25 to 95% by mass of (C) a polyolefin based resin,

wherein the ratio of the mass Wg of the graphite (B) to the mass Wcf of the carbon fiber (A) (Wg/Wcf) is from 1 to 10.

Each of the components which constitute the composition of the invention is described hereinafter.

### (A) Carbon Fiber

The carbon fiber gives a high rigidity to the composition of the invention. It is the so-called reinforcing component of the molded product obtained from the composition, and is simultaneously a component necessary for making the composition of the invention low in density and ash content.

The type of the carbon fiber used in the composition of the invention is not particularly limited, and the carbon fiber may be of a polyacrylonitrile (PAN) type (HT, IM or HM), a pitch type (GP or HM), or a rayon type. The PAN type is preferred.

The tensile strength of the carbon fiber is preferably 1000 MPa or more, more preferably 3000 MPa or more. If the tensile strength is less than 1000 MPa, sufficient reinforcement and strengthening may not be obtained.

The tensile elasticity of the carbon fiber is preferably 50 GPa or more, more preferably 200 GPa or more. If the tensile elasticity is less than 50 GPa, sufficient reinforcement and strengthening may not be obtained.

The carbon fiber used in the composition of the invention needs to have a filament diameter of from 3 to 20 μm, preferably from 4 to 8 μm. If the filament diameter is less than 3 μm, the filaments are easily bent so that the strength may fall, and the industrial manufacturing costs impractically increase. If the diameter is more than 20 μm, the fiber is small in the aspect ratio of the filaments, and costs impractically increase.

The filament diameter of the carbon fiber can be measured with an electron microscope.

Examples of the method for producing the carbon fiber having a filament diameter in the above-mentioned range include methods described in JP-A-2004-11030, JP-A-2001-214334, JP-A-H5-261792, and “New Guide to Carbon Material” (edited by the Carbon Society of Japan and published by Realize Corp. in 1996).

Any carbon fiber with the above-mentioned filament diameter may be used. Commercially available products may be also used. Specific examples thereof include Besfight (registered trade mark) chopped fibers HTA-C6-S, HTA-C6-SR, HTA-C6-SRS, HTA-C6-N, HTA-C6-NR, HTA-C6-NRS, HTA-C6-US, HTA-C6-UEL1, HTA-C6-UH, HTA-C6-OW, HTA-C6-E, and MC HTA-C6-US, which are each manufactured by Toho Tenax Co., Ltd.; Besfight (registered trade mark) filaments HTA-WO5K, HTA-WLK, HTA-3K, HTA-6K, HTA-12K, HTA-24K, UT-500-6K, UT500-12K, UT-500-24K, UT800-24K, IM400-3K, IM400-6K, IM400-12K, IM600-6K, IM600-12K, IM600-24K, LM16-12K, HM35-12K, TM35-6K, UM40-12K, UM40-24K, UM46-12K, UM55-12K, UM63-12K, and UM68-12K, which are each manuf actured by Toho Tenax Co., Ltd.; Pyrrofill (registered trade mark) chopped fibers TR066, TRO66A, TR068, TR06U, TR06NE and TR06G, which are each manufactured by Mitsubishi Rayon Co., Ltd.; and Torayca chopped fibers T008A-003, and T010-003, which are each manufactured by Toray Industries, Inc.

The carbon fiber is preferably subjected to surface treatment, in particular, electrolytic treatment. Examples of the surface treating agent include epoxy type sizing agents, urethane type sizing agents, nylon type sizing agents, and olefin type sizing agents. The surface treatment improves the tensile strength and the bending strength. The carbon fiber subjected to the surface treatment may be commercially available one. Specific examples thereof include Besfight (registered trade mark) chopped fibers HTA-C6-SRS, HTA-C6-S, HTA-C6-SR, and HTA-C6-E, which are each treated with an epoxy type sizing agent, HTA-C6-N, HTA-C6-NR, and HTA-C6-NRS, which are each treated with a nylon type sizing agent, and HTA-C6-US, HTA-C6-UEL1, HTA-C6-UH, and MC HTA-C6-U, which are each treated with a urethane type sizing agent (all of them being manufactured by Toho Tenax Co., Ltd.); and Pyrrofill (registered trademark) chopped fibers TR066 and TRO66A, which are each treated with an epoxy type sizing agent, TR068, which is treated with an epoxy-urethane type sizing agent, TR06U, which is treated with a urethane type sizing agent, TR06NE, which is treated with a polyamide type sizing agent, and TR06G, which is water-solubly sized (all of them being manufactured by Mitsubishi Rayon Co., Ltd.).

The blend ratio of the carbon fiber (A) in the composition of the invention is from 1 to 25% by mass, preferably from 1 to 20% by mass, more preferably from 2 to 12% by mass, even more preferably from 3 to 8% by mass. If the ratio is less than 1% by mass, the reinforcement and strengthening are insufficient and further the carbon fiber is uniformly dispersed into the resin with difficulty. If the ratio is more than 25% by mass, costs for the production impractically increase.

### (B) Graphite

In the composition of the invention, graphite is a filler having a plate-like shape, and is a component having a function of preventing curvature and deformation of the molded product obtained from the composition of the invention comprising this.

The graphite used in the composition of the invention is not limited to any especial kind. Any graphite such as artificial graphite powder, soil-form graphite powder, scaly graphite powder and lamellar graphite may be used. The scaly graphite powder and lamellar graphite are preferred, and the lamellar graphite is particularly preferred.

The graphite used in the composition of the invention has an average particle size of 1 to 100 μm, preferably 5 to 80 μm, more preferably 20 to 60 μm. If the average particle size of the graphite is less than 1 μm, a curvature and deformation of the molded product obtained from the composition comprising this is not sufficiently prevented. If the average particle size is more than 100 μm, the impact strength tends to lower. The average particle size of the graphite is measured by a laser diffraction scattering method according to JIS R 1629.

The graphite may be commercially available one. Specific examples thereof include PAG5 (artificial graphite powder manufactured by Nippon Graphite Industry Co., Ltd., average particle size: 30 μm), AOP (soil-form graphite powder manufactured by Nippon Graphite Industry Co., Ltd., average particle size: 5 μm), CB-150 (scaly graphite powder manufactured by Nippon Graphite Industry Co., Ltd., average particle size: 40 μm), and GR-15 (lamellar graphite powder manufactured by Nippon Graphite Industry Co., Ltd., average particle size: 15 μm). Besides, examples of the artificial graphite powder include PAG series and HAG series manufactured by Nippon Graphite Industry Co., Ltd.; examples of the soil-form graphite powder include blue P, AP, and P#1 manufactured by Nippon Graphite Industry Co., Ltd.; examples of the scaly graphite powder include CP series, CB series, and F# series manufactured by Nippon Graphite Industry Co., Ltd.; examples of the lamellar graphite include EXP-P, EP, and CMX manufactured by Nippon Graphite Industry Co., Ltd.; and examples of high purity graphite powder include ACP series, ACB series, SP series, and HOP series manufactured by Nippon Graphite Industry Co., Ltd.

The volatile matter content in the graphite is usually 5% or less, preferably 2% or less, more preferably 1% or less, even more preferably 0.5% or less. If the volatile matter content is large, a problem is caused about the endurance or gas is involved into the composition when the composition is molded so that the external appearance may be damaged.

The blend ratio of the graphite (B) in the composition of the invention is from 3 to 50% by mass, preferably from 3 to 20% by mass, more preferably from 5 to 18% by mass. If the blend ratio of the graphite (B) is less than 3% by mass, the curvature-decreasing effect cannot be expected. If the ratio is more than 50% by mass, the density of the composition or the molded product obtained therefrom becomes large (or gets heavy) so as to damage an advantage of the use of the carbon fiber (i.e., a low density).

### (C) Polyolefin Based Resin

In the composition of the invention, the polyolefin based resin is a matrix resin. The polyolefin based resin is not limited to any especial kind, and is preferably a polypropylene based resin. Preferred examples of the polypropylene based resin include propylene homopolymer, ethylene-propylene block copolymer, and ethylene-propylene random copolymer.

The melt flow rate (hereinafter abbreviated to MFR) of the polyolefin based resin used in the composition of the invention is usually from 1 to 500 g/10-minutes, preferably from 10 to 300 g/10-minutes, more preferably from 15 to 80 g/10-minutes. If the MFR is less than 1 g/10-minutes, the composition is not easily molded. If the MFR is more than 500 g/10-minutes, the impact strength may lower.

The Mw/Mn of the polyolefin based resin, which is measured by GPC, is usually from 2 to 10, preferably from 2 to 5, more preferably from 2 to 4.

The polyolefin based resin may be commercially available one. Specific examples thereof include J-2003GP (manufactured by Idemitsu Petrochemical Co., Ltd., MFR=20 g/10-minutes), J-3000GP (manufactured by Idemitsu Petrochemical Co., Ltd., MFR=30 g/10-minutes), Y-6005GM (manufactured by Idemitsu Petrochemical Co., Ltd., MFR=60 g/10-minutes), F-300SV (manufactured by Idemitsu Petrochemical Co., Ltd., MFR=3 g/10-minutes), J-6083HP (manufactured by Idemitsu Petrochemical Co., Ltd., MFR=60 g/10-minutes), J-3054 MP (manufactured by Idemitsu Petrochemical Co., Ltd., MFR=30 g/10-minutes), J-762HP (manufactured by Idemitsu Petrochemical Co., Ltd., MFR=12 g/10-minutes), J-466HP (manufactured by Idemitsu Petrochemical Co., Ltd., MFR=4 g/10-minutes), and J-784HV (manufactured by Idemitsu Petrochemical Co., Ltd., MFR=12 g/10-minutes).

The blend ratio of the polyolefin based resin (C) in the composition of the invention is from 25 to 95% by mass, preferably from 50 to 90% by mass, more preferably from 60 to 85% by mass. If the blend ratio of the polyolefin based resin (C) is less than 25% by mass, the moldability of the composition is poor. If the ratio is more than 95% by mass, the rigidity and the heat resistance are insufficient.

In the composition of the invention, the ratio of the mass Wg of the graphite (B) to the mass Wcf of the carbon fiber (A), (Wg/Wcf), is from 1 to 10, preferably from 1.5 to 5, more preferably from 2 to 4. If the ratio Wg/Wcf is less than 1, the curvature or deformation may not be improved. If the ratio is more than 10, the rigidity of the molded product obtained from the composition containing these may be insufficient.

A functional-group-containing polyolefin, which may be referred to as a “component D” hereinafter, is preferably incorporated into the composition of the invention comprising the components (A) to (C). The following describes the component (D).

### (D) Functional-Group-Containing Polyolefin

The interface strength between the polyolefin based resin (C) and the carbon fiber (A) can be improved by adding the functional-group-containing polyolefin to the composition of the invention.

Examples of the functional group of the functional-group-containing polyolefin that may be used in the composition of the invention include carboxylic acid, amino, epoxy, and hydroxyl groups. The carboxylic acid and amino groups are preferred. Examples of the carboxylic acid group include maleic acid, fumaric acid, and acrylic acid groups. The maleic acid group is preferred.

The functional-group-containing polyolefin is preferably a carboxylic-acid-modified polyolefin based resin, more preferably malic-acid-modified polypropylene wherein the percentage of the added acid is from 0.1 to 10% by mass.

The acid-modified polyolefin may be commercially available one. Specific examples thereof include Polybond 3200 and Polybond 3150 (maleic-acid-modified polypropylene, manufactured by Shiraishi Calcium Kaisha, Ltd.), Umex 1001, Umex 1010, Umex 1003 and Umex 1008 (maleic-acid-modified polypropylene, manufacturedby Sanyo Chemical Industries, Ltd.), Adomer QE800 and Adomer QE810 (maleic-acid-modified polypropylene, manufactured by Mitsui Chemicals, Inc.), and Toyotaff H-1000P (maleic-acid-modified polypropylene, manufactured by Toyo Kasei Kogyo Co., Ltd.).

The blend ratio of the functional-group-containing polyolefin (D) in the composition of the invention is from 0.1 to 20 parts by mass, preferably from 0.5 to 10 parts by mass, more preferably from 1 to 5 parts by mass per 100 parts by mass of the total of the components (A) to (C). If the blend ratio of the functional-group-containing polyolefin (D) is less than 0.1% by mass, the bending strength and the heat resistance (heat distortion temperature) lower. If the ratio is more than 20% by mass, costs for the production impractically increase.

The ash content in the composition of the invention is usually 5% or less by mass, preferably 3% or less by mass, more preferably 1% or less by mass, even more preferably 0.5% or less by mass. The ash content is a value when the composition is burned at 900° C. in the presence of oxygen for 6 hours. If the ash content is more than 5% by mass, the property of the carbon fiber (A) that the ash content is low is not unfavorably exhibited. Details of the method for ashing the composition and the measurement of the ash content are described below.

The ashing is performed by putting a sample into a heat-resistant container and then heating the container with an electrical furnace. The ash content is obtained by measuring the mass of the sample before and after the incineration with an electronic balance and then calculating the expression of (the mass after the burning)/(the mass before the burning).

The average aspect ratio of the carbon fiber in the composition of the invention (that is, (the average fiber length)/(the average fiber diameter)) is usually from 5 to 10,000, preferably from 10 to 5,000, more preferably from 500 to 2,000. If the average aspect ratio is less than 5, the reinforcing effect is low. If the ratio is more than 10,000, the moldability may deteriorate.

The composition of the invention can be usually produced as follows.

The raw materials are mixed (dry-blended), and then the mixture is melted and kneaded with an extruder, whereby the composition can be produced. The extruder may be a known extruder such as a short axis extruder or a biaxial extruder. The carbon fiber (A) may be mixed and charged thereinto together with the other raw materials, or may be separately charged thereinto from a side feed. Besides, the following method may be used: a method described in JP-A-S62-60625, JP-A-H10-264152, WO 97/19805 or some other documents.

Various additives in addition to the components (A) to (D) may be incorporated into the composition of the invention as long as the object of the invention is attained. Examples of the additives that can be incorporated include a colorant, an antioxidant, a metal inactivating agent, carbon black, a nucleus-increasing agent, a releasing agent, a lubricant, and an antistatic agent. Reinforcing agents, such as various elastomers, mica, talc, glass fiber and organic fiber, may be added to the composition.

The following describes the molded product obtained by molding the composition of the invention. The molded product of the invention is a molded product obtained by molding the composition of the invention. The method for the molding is not particularly limited, and may be any method known by those skilled in the art. Examples of the molding method include injection molding, injection compression molding, extrusion molding, expansion molding, and foam molding. The injection molding and injection compression molding are preferred.

The density of the molded product of the invention is preferably 1100 kg/m³ or less, more preferably 1000 kg/m³ or less, even more preferably 970 kg/m³ or less. If the density of the molded product is more than 1100 kg/m³, the property of the carbon fiber (A) that the density is low may not be unfavorably exhibited. The density of the molded product is measured according to JIS K 7112:1999.

The flexural modulus of the molded product of the invention is preferably 3000 MPa or more, more preferably 3800 MPa or more. If the flexural modulus of the molded product is less than 3000 MPa, the property of the carbon fiber (A) that the rigidity is high may not be unfavorably exhibited. The flexural modulus of the molded product is measured according to JIS K-7171:1994.

The molded product of the invention has properties of a low density, a low ash content and a high rigidity, which are preferred characteristics of carbon fiber reinforced resin material, and is small in curvature and deformation.

### EXAMPLES

The present invention is described in more detail by way of the following examples. However, the present invention is not limited thereto.

### Example 1

Materials shown in Table 1 were mixed (dry-blended), and then the mixture was charged into a biaxial extruder (TEM-35B, manufactured by Toshiba Machine Co., Ltd., barrel temperature: 200° C., screw revolution number: 300 rpm) from its top feed, melted and kneaded to yield a fiber reinforced resin composition.

### Examples 2 to 4 and Comparative Examples 1 to 3

Fiber reinforced resin compositions were each produced in the same way as in Example 1 except that the composition of the components was changed to each composition shown in Table 1.

### <Evaluation of Properties of Molded Products>

From the fiber reinforced resin compositions of Examples 1 to 4 and Comparative Examples 1 to 3, molded products (test pieces) were obtained as described below and then physical properties of the molded products were obtained as described below. The obtained results are shown in Table 1.

### (1) Curvature Ratio (%):

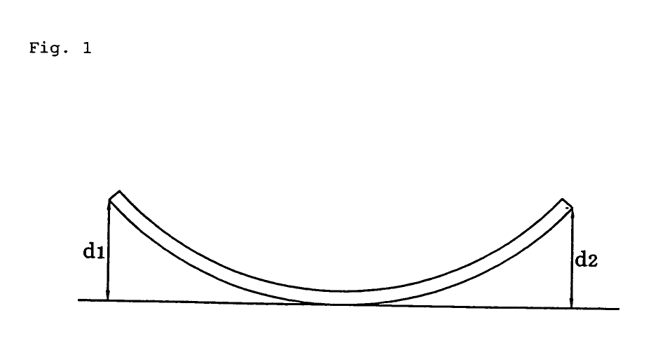

A disk 150 mm in diameter and 2.5 mm in thickness was molded from each of the compositions by injection molding, and then the state thereof was adjusted at 23° C. for 48 hours. Thereafter, d₁ and d₂ were obtained as illustrated in FIG. 1. The curvature ratio was calculated from the following equation:

Curvature ratio (%)={(d₁+d₂)/(2×140)}×100

(2) Density (kg/m³):

The density was measured according to JIS K 7112:1999.

### (3) Flexural Modulus (MPa):

A pellet of each of the compositions was injection-molded to form a test piece (8 cm long, 1 cm wide, and 0.4 cm thick). The state thereof was adjusted at 23° C. for 48 hours, and then the test piece was subjected to a test according to JIS K-7171:1994 to obtain the flexural modulus.

TABLE 1

| | | | Examples | | | | Comparative Examples | | |
|---|---|---|---|---|---|---|---|---|---|
| Composition (% by mass) | | | 1 | 2 | 3 | 4 | 1 | 2 | 3 |
| Component (A) | Carbon fiber | HTA-C6-SRS | 5 | 5 | 5 | 5 | 5 | 10 | 0 |
| Component (B) | Artificial graphite powder | PAG5 | 16 | | | | | | 21 |
| | Soil-form graphite powder | AOP | | 16 | | | | | |
| | Scaly graphite powder | CB-150 | | | 16 | | | | |
| | Lamellar graphite powder | GR-15 | | | | 16 | | | |
| Component (C) | Polypropylene | J-2003GP | 79 | 79 | 79 | 79 | 95 | 90 | 79 |
| Component (D) | Maleic-acid-modified PP | Polybond3200 | 4 | 4 | 4 | 4 | 4 | 4 | 4 |
| | Wg/Wcf | | 3 | 3 | 3 | 3 | 0 | 0 | — |

<Evaluation of molded product properties>

| | | | | | | | | | |
|---|---|---|---|---|---|---|---|---|---|
| Curvature ratio (%) | | mm | 8 | 7 | 4 | 2 | 13 | 10 | 1 |
| Density | | kg/m³ | 1000 | 1000 | 1000 | 1000 | 920 | 950 | 1000 |
| Flexural modulus | JIS K7171:1994 | MPa | 4000 | 4100 | 4000 | 4200 | 2500 | 4500 | 2200 |

Details of abbreviations (trade names) in Table 1 are as follows:

HTA-C6-SRS (manufactured by Toho Tenax Co., Ltd., filament diameter: 7 μm, treated with an epoxy type sizing agent);

Polybond 3200 (maleic-acid-modified polypropylene, manufactured by Shiraishi Calcium Kaisha, Ltd.);

PAG5 (Artificial graphite powder, manufactured by Nippon Graphite Industry Co., Ltd., average particle size: 30 μm);

AOP (Soil-form graphite powder, manufactured by Nippon Graphite Industry Co., Ltd., average particle size: 5 μm):

CB-150 (Scaly graphite powder, manufactured by Nippon Graphite Industry Co., Ltd., average particle size: 40 μm);

GR-15 (Lamellar graphite powder, manufactured by Nippon Graphite Industry Co., Ltd., average particle size: 15 μm); and

J-2003GP (manufactured by Idemitsu Petrochemical Co., Ltd., MFR=20 g/10-minutes).

It can be understood from the results in Table 1 that the curvature ratios of Examples 1 to 4 were as small as 2-8%, the densities were each 1000 kg/m³ and the flexural moduluss were as high as 4000 to 4200 MPa. On the other hand, it can be understood that Comparative Examples 1 to 2, into which no graphite (B) was incorporated, had a small density but had a large curvature ratio. Comparative Example 2, which contained the carbon fiber (A) at an amount twice larger than Examples, had a very high flexural modulus but had a poor curvature ratio. Comparative Example 3, which contained no carbon fiber (A), had a small curvature ratio but had a very low or poor flexural modulus. Comparative Example 1, which contained the carbon fiber (A) at the same amount as Examples, was poor in the curvature ratio and flexural modulus thereof.

### INDUSTRIAL APPLICABILITY

Since the fiber reinforced resin composition of the present invention gives a molded product high in rigidity and small in curvature and deformation, the composition is useful as a material for producing automobile parts (such as front ends, fan shrouds, cleaning fans, engine under-covers, engine covers, radiator boxes, side doors, back door interiors, back door exteriors, outside plates, roof rails, door handles, luggage boxes, wheel covers, handles, cleaning modules, air clearer cases, air cleaner parts, and lock nuts); two-wheeled vehicle or bicycle parts (such as luggage boxes, handles, and wheels); house-connected parts (such as hot-water-washing toilet seat parts, bath room parts, bathtub parts, chair legs, valves, and meter boxes); and other members (such as washing machine parts (such as baths and balance rings), fans for wind power generation, power tool parts, mowing machine handles, hose joints, resin bolts, and molds for concrete).

1: A fiber reinforced polyolefin based resin composition, comprising:
1 to 25% by mass of (A) a carbon fiber having a filament diameter of 3 to 20 μm,
3 to 50% by mass of (B) a graphite having an average particle size of 1 to 100 μm, and
25 to 95% by mass of (C) a polyolefin based resin,
wherein the ratio of the mass Wg of the graphite to the mass Wcf of the carbon fiber (Wg/Wcf) is from 1 to 10.

2: The composition according to claim 1, wherein the carbon fiber (A) is present in an amount of 1 to 20% by mass.

3: The composition according to claim 1, further comprising 0.1 to 20 parts by mass of (D) a functional-group-containing polyolefin per 100 parts by mass of the total of the carbon fiber (A), the graphite (B) and the polyolefin based resin (C).

4: The composition according to claim 1, wherein the polyolefin based resin (C) is a polypropylene based resin.

5: The composition according to claim 1, which has an ash content of 3% or less by mass when the composition is burned at 900° C. in the presence of oxygen for 6 hours.

6: A molded product obtained by molding the composition according to claim 1.

7: The molded product according to claim 6, which has a density of 1100 kg/m³ or less.

8: The molded product according to claim 6, which has a flexural modulus of 3000 MPa or more.
